(19) United States
(12) Patent Application Publication
(10) Pub. No.: US 2015/0247779 A1
(43) Pub. Date: Sep. 3, 2015

(54) OPTICAL INTEGRATED CIRCUIT, AND INSPECTION METHOD OF OPTICAL DEVICE IN OPTICAL INTEGRATED CIRCUIT

(71) Applicant: NEC Corporation, Minato-ku, Tokyo (JP)

(72) Inventor: Daisuke Okamoto, Tokyo (JP)

(21) Appl. No.: 14/422,986

(22) PCT Filed: Jun. 25, 2013
(86) PCT No.: PCT/JP2013/067299

§ 371 Date: Feb. 20, 2015

(30) Foreign Application Priority Data
Aug. 29, 2012 (JP) 2012-188510

(51) Int. Cl. G01M 11/02

(52) U.S. Cl. CPC G01M 11/0207

(57) ABSTRACT

The present invention simply and reliably inspects characteristics of a plurality of optical devices in a wafer state. This optical integrated circuit is provided with: an optical coupler having light inputted thereto from the surface of a semiconductor substrate; an optical waveguide that propagates inspection light inputted to the optical coupler; a light distributor that distributes inspection light to the optical waveguides, said inspection light having been propagated by means of the optical waveguide; and optical devices that are respectively provided on the optical waveguides having the light distributed thereto using the light distributor.

### TECHNICAL FIELD

The present invention is related to an optical integrated circuit that is used in an optical communication system and an optical information processing system, and an inspection method of an optical device in the optical integrated circuit.

### BACKGROUND ART

For example, as discussed in Patent literature 1 (PTL 1), an optical integrated circuit that is used in an optical communication system and an optical information processing system has being provided with high-performance at low-cost by using a method of preparing an optical integrated circuit including an optical waveguide that is obtained by providing a core layer made of a silicon-based material and a cladding layer on a silicon substrate.

In an optical integrated circuit in which a large number of optical devices is integrated, it is desirable to select a good device by inspecting optical characteristics of the optical devices in the wafer state, prior to dicing of the optical integrated circuit in the wafer state to divide the optical integrated circuit into respective modules.

Therefore, for example, in Non-Patent literature 1 (NPL 1), an optical coupler has been disclosed that receives light from the optical fiber through the wafer surface and couples the light to the optical waveguide using a diffraction grating (grating). As a result of usage of the optical coupler, the optical integrated circuit in the wafer state can be inspected before the dicing.

### CITATION LIST

### Patent Literature

### [PTL 1] Japanese Laid-open Patent Publication No. 2011-232567

### Non-Patent literature

### [NPL 1] Attila Mekis et al., “A Grating-Coupler-Enabled CMOS Photonics Platform”, IEEE JOURNAL OF SELECTED TOPICS IN QUANTUM ELECTRONICS, VOL. 17, NO. 3, pp. 597-608, 2011 (FIG. 3).

### SUMMARY OF THE INVENTION

### Technical Problem

However, in the optical integrated circuit in the wafer state, the characteristic inspection of the large number of optical devices is required. The optical integrated circuit is densely formed, so that high alignment accuracy is requested when the optical fiber is coupled to the optical waveguide of the optical integrated circuit through the optical coupler at the time of inspection.

The characteristic inspection of the optical device is performed by coupling the optical fiber to the optical waveguide in which the optical device is provided, through the optical coupler, inputting inspection light to the optical waveguide from the optical fiber, and monitoring the output light. Therefore, when all of the optical devices that are respectively provided in a large number of modules on the wafer are inspected, there is a problem that a lot of time is taken, and an increase in cost is caused.

In addition, inspection of a plurality of optical devices at the same time can be performed by using a plurality of sets of optical fibers and optical couplers. However, in that case, a variance of coupling losses occurs between the plurality of optical couplers and the optical fibers, with the variation in the characteristics between the plurality of sets of optical couplers, thereby causing a problem of inspection accuracy of the optical device characteristic.

An object of the present invention, which has been made for the problems, is to provide an optical integrated circuit in which characteristics of a large number of optical devices can be inspected simply and reliably in the wafer state, and an inspection method of an optical device in an optical integrated circuit.

### Solution to Problem

The present invention employs the following means in order to solve the above-described problems.

That is, an optical integrated circuit according to the present invention includes an optical coupler that receives light through the surface of a semiconductor substrate, an optical waveguide that propagates the inspection light that has been received in the optical coupler, a light distributor that distributes the inspection light that has been propagated through the optical waveguide to a plurality of optical waveguides, and optical devices that are respectively connected to the plurality of optical waveguides to which the inspection light is distributed by the light distributor.

In addition, an inspection method of optical devices in the optical integrated circuit according to the present invention as described above includes receiving the inspection light through the optical coupler, distributing the inspection light to the plurality of optical waveguides using the light distributor, and evaluating the optical characteristic of the optical device based on output light that is obtained by passing the distributed inspection light through the optical device.

### Advantageous Effects of Invention

In the present invention, by distributing light that is received from a single optical coupler, to a plurality of optical waveguides in which optical devices are respectively provided, characteristics of the large number of optical devices can be inspected simply and reliably in the wafer state.

### BRIEF DESCRIPTION OF DRAWINGS

FIG. 1 is a diagram illustrating a configuration of an inspection circuit that is provided in an optical integrated circuit on a wafer according to a first exemplary embodiment.

FIG. 2 is a diagram illustrating a configuration of an inspection circuit that is provided in an optical integrated circuit on a wafer according to a second exemplary embodiment.

FIG. 3A is a diagram illustrating a method of evaluating a waveguide having a certain length from detected results in two waveguides having different lengths.

FIG. 3B is a diagram illustrating a method of evaluating a waveguide having a certain length from detected results in two waveguides having different lengths.

FIG. 3C is a diagram illustrating a method of evaluating a waveguide having a certain length from detected results in two waveguides having different lengths.

FIG. 4 is a diagram illustrating a configuration of an inspection circuit that is provided in an optical integrated circuit on a wafer according to a third exemplary embodiment.

FIG. 5 is a diagram illustrating a configuration of an inspection circuit that is provided in an optical integrated circuit on a wafer according to a fourth exemplary embodiment.

FIG. 6 is a diagram illustrating a configuration of an inspection circuit that is provided in an optical integrated circuit on a wafer according to a fifth exemplary embodiment.

FIG. 7 is a diagram illustrating a configuration of an inspection circuit that is provided in an optical integrated circuit on a wafer according to a sixth exemplary embodiment.

FIG. 8 is a diagram illustrating a configuration of an inspection circuit that is provided in an optical integrated circuit on a wafer according to a seventh exemplary embodiment.

FIG. 9 is a diagram illustrating a configuration of an inspection circuit that is provided in an optical integrated circuit on a wafer according to an eighth exemplary embodiment.

### DESCRIPTION OF EMBODIMENTS

An optical integrated circuit, and an inspection method of an optical device in the optical integrated circuit according to exemplary embodiments of the present invention are described below with reference to drawings. However, the present invention is not limited to these exemplary embodiments.

### First Exemplary Embodiment

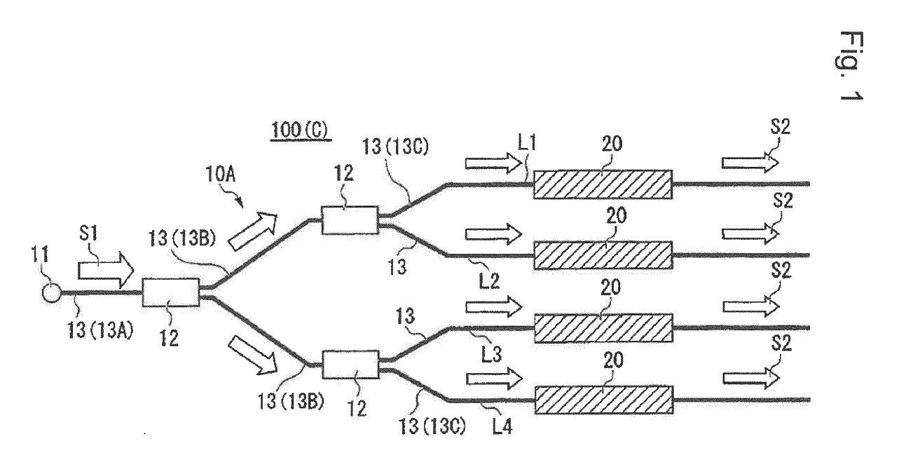

FIG. 1 schematically illustrates an example of an inspection circuit 10A that is formed on a wafer (semiconductor substrate) 100.

As illustrated in FIG. 1, on the wafer 100 on which a plurality of optical integrated circuits C is formed, a plurality of optical devices 20 and the inspection circuit 10A that inspects the optical characteristics by emitting inspection light to the optical devices 20 are formed in each of the optical integrated circuits C.

The inspection circuit 10A includes an optical coupler 11, a light distributor 12 that distributes light, and an optical waveguide 13 that are provided on the wafer 100.

The wafer 100 is made of a semiconductor substrate material, but is not particularly limited to the specific material, and may be either silicon or a compound semiconductor.

The optical coupler 11 includes a function that causes inspection light S1 that has been received through the surface of the wafer 100 to be coupled to the optical waveguide 13A that is connected to the optical coupler 11. For example, the optical coupler 11 can be constituted by a diffraction grating, a 45 degree mirror, or the like. Preferably, for the optical coupler 11, a diffraction grating is used that can be prepared by a general semiconductor process, and in which a wavelength band, an incidence angle of light, and the like can be designed flexibly. The waveband of the inspection light S1 that is input from the optical coupler 11 is also not particularly limited, and an optimal waveband of the inspection light S1 can be used as appropriate by considering a substrate material, a manufacturing process, and the like.

The light distributor 12 distributes light that has been propagated through the optical waveguide 13, to optical waveguides 13 having a plurality of channels. In the exemplary embodiment, the light distributor 12 distributes the light that has been propagated through the optical waveguide 13 having a single channel, to the optical waveguides 13 having two channels. For example, the optical waveguides 13B having the two channels are connected to the light distributor 12 that is connected to the optical coupler 11 through the optical waveguide 13A, and light distributors 12 are respectively provided to the optical waveguides 13B and 13B having the two channels, and the light is distributed to the optical waveguides 13C and 13C of two channels. In addition, the optical waveguides 13C that have been branched into the four channels in total as described above are respectively connected to input ports of the optical devices 20.

For the light distributor 12, a distribution coupler having a Y-shaped branch structure, or the like, may be used, or a multi-mode interferometer may be used. In addition, as the light distributor 12, an optical switch may be used. In this case, by switching the optical switch, light is supplied to the optical waveguides 13 having the plurality of channels alternately, and the light is distributed in time-division. The optical switch can select the optical waveguide 13 that is a supply destination of the light in accordance with electrical control. When the distribution coupler or the like is used for the light distributor 12, the light is distributed to the optical waveguides 13 having the plurality of channels at the same time, so that the energy of the light is reduced in each of the optical waveguides 13 that are the supply destinations due to the distribution. On the other hand, when the optical switch is used for the light distributor 12, the light is supplied to the optical waveguides 13 that are the distribute destinations in time-division, so that the energy of the inspection light can be increased without attenuation of the light due to the distribution. Thus, the small energy of the inspection light S1 is sufficient.

As describe above, a path is divided into four paths L1 to L4 from the optical coupler 11 to the optical devices 20.

In the exemplary embodiment, these four paths L1 to L4 are formed so that the path lengths from the optical coupler 11 to the optical devices 20 become equal. For example, it is assumed that the two optical waveguides 13B and 13B between the light distributor 12 at the first stage viewed from the optical coupler 11 and the light distributor 12 at the second stage viewed from the optical coupler 11 have equal lengths, and the four optical waveguides 13C, 13C, . . . between the two light distributors 12 at the second stage and the respective optical devices 20 have equal lengths.

In such a configuration, the inspection light S1 that has been received in the optical coupler 11 through the surface of the wafer 100 using the optical fiber or the like is propagated through the optical waveguide 13, distributed to the plurality of channels using the light distributors 12, 12, . . . , and reached the optical devices 20.

In addition, various optical characteristics of the optical devices 20 can be inspected by monitoring the pieces of output light S2 that have passed through the optical devices 20. For example, when the optical device 20 is an optical modulator, a loss, an extinction ratio, a frequency characteristic, and the like can be inspected.

In order to monitor the output light S2, on the same wafer 100 on which the optical device 20 is provided, a light receiving element is provided, and such light is converted into an electrical signal, and the monitoring can be performed using such an electrical signal. In addition, a diffraction grating or the like is provided at the subsequent stage of the optical device 20, and the light that has passed through the optical device 20 is caused to be emitted to the outside through the surface of the wafer 100 and coupled to the optical fiber or the like to monitor such light.

By using the configuration as described above, when the inspection light S1 is merely input to the single optical coupler 11, the characteristics of the plurality of optical devices 20 can be inspected. Thus, the large number of optical devices 20 can be inspected on the wafer 100 simply and efficiently.

In addition, to the four optical devices 20 that are to be inspected at the same time, the inspection light S1 is input through the identical optical coupler 11, so that highly accurate detection can be achieved without being affected by the variation in the characteristics of the optical couplers 11.

In addition, the paths L1 to L4 from the optical coupler 11 to the optical devices 20 are formed so that the path lengths of the paths become equal, so that the energy of the inspection light S1 is equally distributed to each of the optical devices 20. As a result, highly accurate comparison using absolute values of the detected results can be performed between the optical devices 20. Therefore, the energy distribution of the output light S2 that is output from each of the optical devices 20 is measured, and a deviation from an average value of the distributions is calculated for each of the optical devices 20, and it can be also detected that the optical device 20 has a bug when the obtained deviation exceeds a deviation that has been set beforehand.

It is noted that, in the above-described first exemplary embodiment, the configuration is applied in which the light distributors 12 are arranged at two stages in series, but the light distributor 12 may be arranged only at a single stage, or at three stages or more.

In addition, the number of channels to which pieces of light are distributed using the light distributor 12 may be three or more, and is not limited to two.

Therefore, for example, when the number of distributions in each of the light distributors 12 is increased as the number of stages of the light distributors 12 is increased, the number of channels to which the pieces of light are distributed from the single optical coupler 11 can be increased significantly.

### Second Exemplary Embodiment

A second exemplary embodiment of the present invention is described below. In the second exemplary embodiment that is described below, the same symbol is assigned to a configuration that is common with that of the above-described first exemplary embodiment, in the figure, and the description is omitted, and a difference from the above-described first exemplary embodiment is mainly described herein.

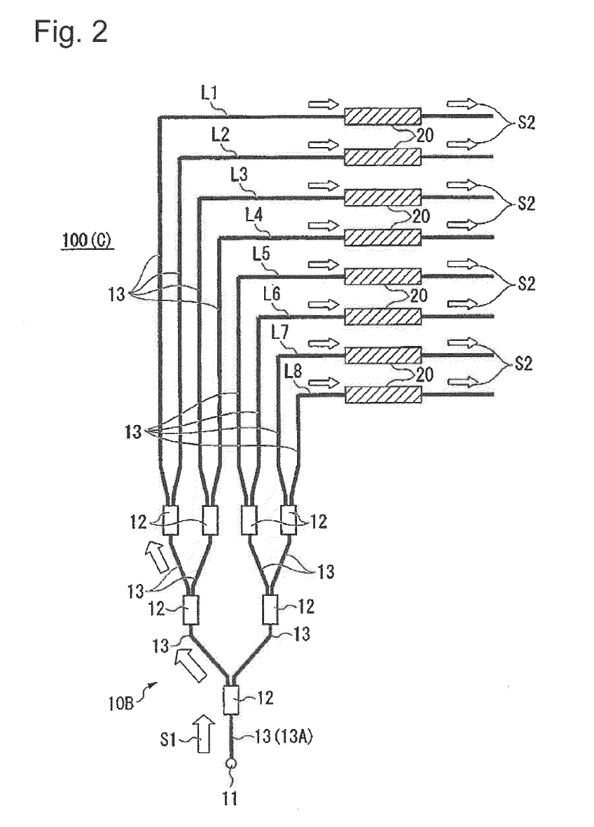

As illustrated in FIG. 2, it is assumed that, in an inspection circuit 10B of an optical integrated circuit C according to the exemplary embodiment, the paths L1 to L8 that pass through from the optical coupler 11 to the light distributors 12 at a plurality of stages (three stages in the exemplary embodiment) and reach the optical devices 20 have unequal lengths. In the above-described first exemplary embodiment, the example is described in which the paths L1 to L4 have equal lengths, but when the optical integrated circuit C is laid out on the semiconductor substrate in practice, there is a case in which the paths L1 to L8 have different lengths due to a constraint condition such as an electrical and physical space, electrical and optical crosstalk, stray light, and a minimum bending dimension of the optical waveguide 13. In the exemplary embodiment of FIG. 2, such a case is schematically illustrated.

In such a configuration, it is considered that, the output light S2 from each of the devices 20 includes contribution of a propagate loss of the optical waveguide 13 in each of the paths L1 to L8 in order to obtain an optical characteristic of each of the optical devices 20 with a high degree of accuracy.

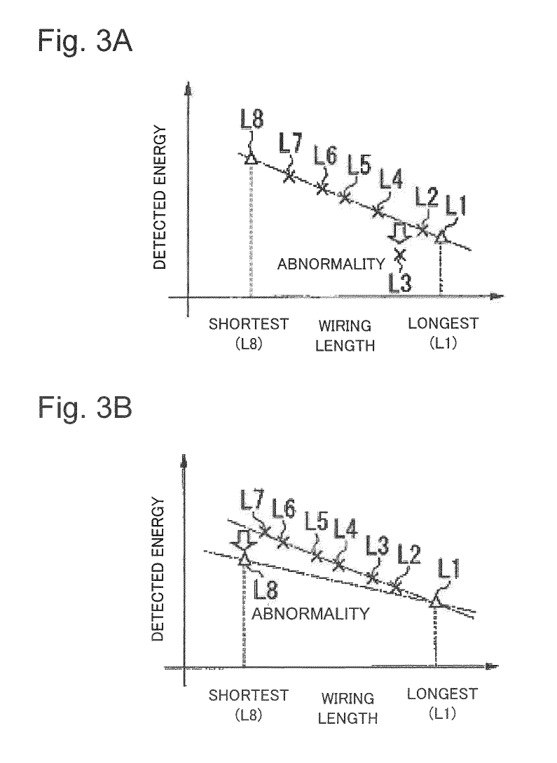

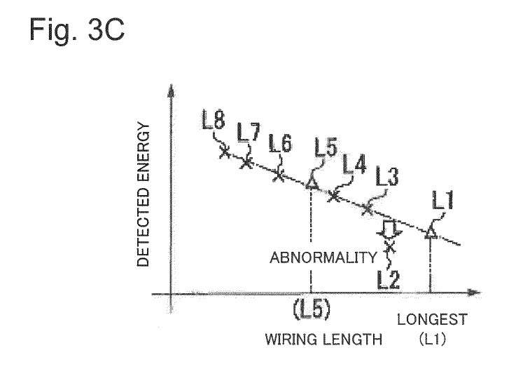

Each of FIGS. 3A, 3B, and 3C illustrates a relationship between a wiring length and a change in detected energy due to the influence of a loss depending on the wiring length. In this case, as illustrated in FIGS. 3A and 3B, based on the strength of light energy in the longest path L1, and the strength of light energy in the shortest path L8, a reference value of light energy in each of the paths L2 to L7 having the intermediate lengths is calculated (one-dot chain lines in FIGS. 3A and 3B). In addition, malfunction in the optical device 20 can be determined depending on whether or not a deviation of the measured value of the light energy in each of the paths L2 to L7 from the reference value is a value or more, which has been defined beforehand.

In addition, in such a configuration, in a case in which the optical device 20 that is an inspection target has nonlinearity for input light energy, even when pieces of wiring of the optical waveguides 13 of the paths L1 to L8 do not have equal lengths, it may need to equalize pieces of distributed light energy.

In this case, as long as an energy branching ratio in the light distributor 12 is adjusted, pieces of light energy that are to be input to the optical devices 20 can be equalized.

In addition, when the propagate loss of each of the paths L1 to L8 is adjusted by selecting the material and the dimension of the optical waveguide 13 as appropriate, it can be assumed that pieces of inspection light energy that are input to the optical devices 20 are equalized. More specifically, as the optical waveguide 13, a material having less loss such as polymer, SiON, and SiN can be used. Alternatively, the adjustment of the propagate loss can be achieved by changing the width of the optical waveguide 13.

It is noted that, in the above-described second exemplary embodiment, it is assumed that, based on the strength of light energy in the longest path L1 and the strength of light energy in the shortest path L8, a reference value of light energy in the paths L2 to L7 having the intermediate lengths is calculated. In addition, as illustrated in FIG. 3C, in addition to the combination of the longest path L1 and the shortest path L8, based on the strengths of pieces of light energy of the optical devices 20 in two or more paths (for example, paths L5 and L1), a reference value of light energy in paths having path lengths that are different from those of the paths L5 and L1 (paths L2, L3, L4, L6, L7, and L8 in this example) is calculated, and the measured values of these paths can be also evaluated.

### Third Exemplary Embodiment

A third exemplary embodiment of the present invention is described below. In the third exemplary embodiment that is described below, the same symbol is assigned to a configuration that is common with those of the above-described first and second exemplary embodiments, in the figure, and the description is omitted, and a difference from the above-described first and second exemplary embodiments is mainly described herein.

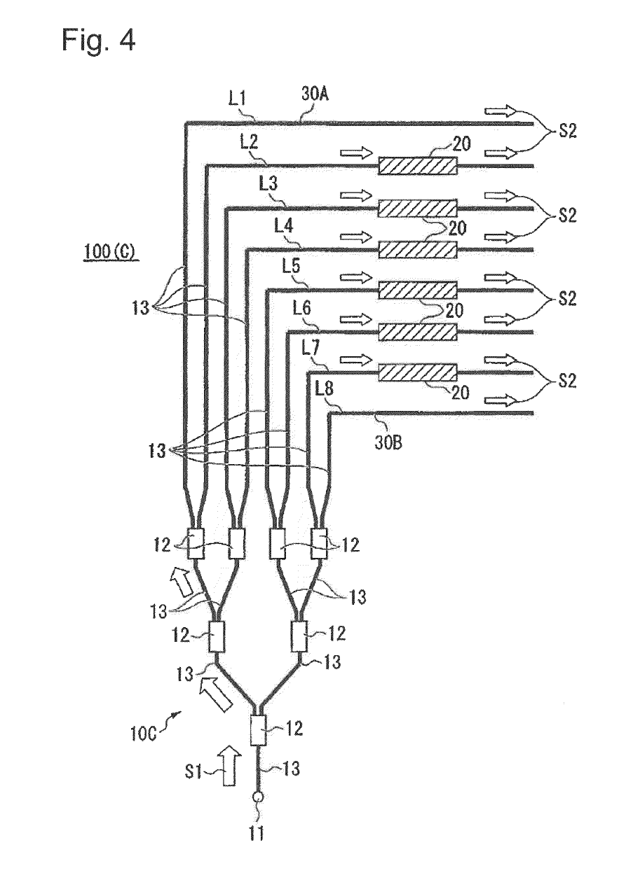

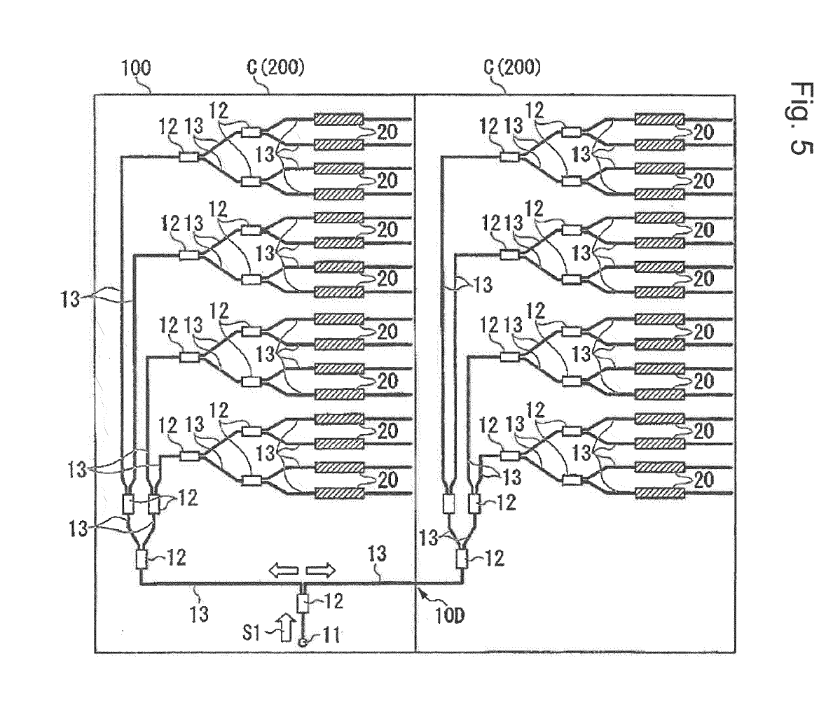

In an inspection circuit 10C of the optical integrated circuit C according to the exemplary embodiment, as illustrated in FIG. 4, it is assumed that two paths from among the paths L1 to L8 to which pieces of light have been distributed using the light distributors 12 are reference optical waveguides 30A and 30B in which the optical devices 20 are not provided, respectively. The reference optical waveguides 30A and 30B are respectively formed by the optical waveguide 13.

In such an inspection circuit 10C, for each of the paths L2 to L7 in which the optical devices 20 are respectively provided, and the reference optical waveguides 30A and 30B of the paths L1 and L8, the output light S2 of light that is input from the optical coupler 11 is monitored.

At that time, the detected values in the paths L1 and L8 are not affected by the optical devices 20, and the lengths are known based on the design values. Thus, based on the detected values, in each of the paths L2 to L7, a loss of the optical waveguide 13 in which the length is known from a design value can be calculated. When the loss in the optical waveguide 13 is excluded from the detected value in each of the paths L2 to L7, each of the optical devices 20 of the paths L2 to L7 can be evaluated further stably with a high degree of accuracy.

### Fourth Exemplary Embodiment

A fourth exemplary embodiment of the present invention is described below. In the fourth exemplary embodiment that is described below, the same symbol is assigned to a configuration that is common with those of the above-described first to third exemplary embodiments, in the figure, and the description is omitted, and a difference from the above-described first to third exemplary embodiments is mainly described herein.

As illustrated in FIG. 5, in an inspection circuit 10D of the optical integrated circuit C according to the exemplary embodiment, light that has been emitted from the single optical coupler 11 is distributed so that inspection circuit 10D extends over chips 200 and 200 of the plurality of integrated circuits C and C using the light distributors 12.

In such a configuration, inspection of a large number of optical devices 20 can be performed further simply and efficiently.

After the inspection has been finished, and selection of non-defective goods has been performed, division of these chips 200 and 200 may be performed by using mechanical processing such as dicing. In this case, even when the optical waveguides 13 that constitute the inspection circuit 10D are divided for dicing, a trouble does not occur.

It is noted that, in the exemplary embodiment, the inspection circuit 10D is formed so as to extend over the two chips 202 and 200, but the inspection circuit may be formed so as to extend over three or more chips 200, of course.

### Fifth Exemplary Embodiment

A fifth exemplary embodiment of the present invention is described below. In the fifth exemplary embodiment that is described below, the same symbol is assigned to a configuration that is common with those of the above-described first to fourth exemplary embodiments, in the figure, and the description is omitted, and a difference from the above-described first to fourth exemplary embodiments is mainly described herein.

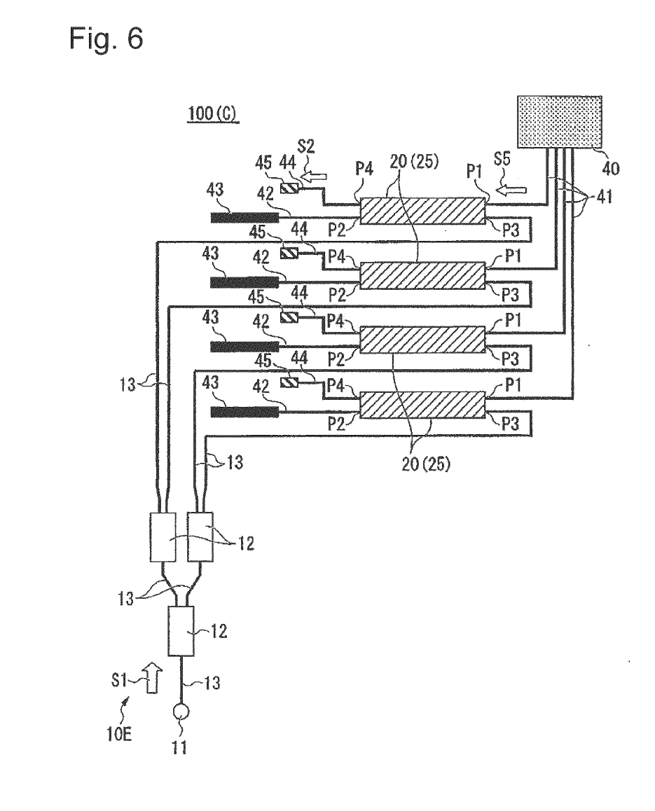

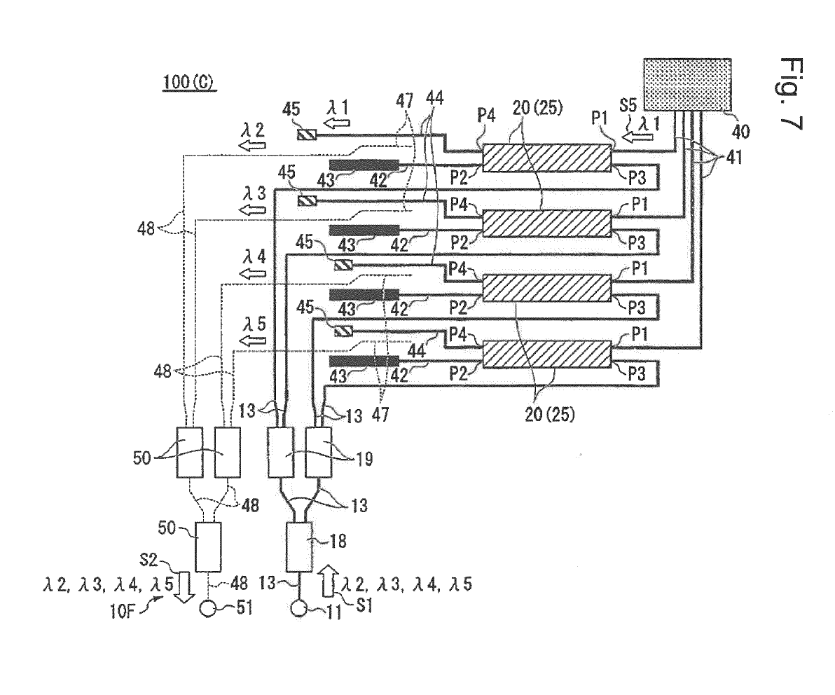

As illustrated in FIG. 6, in an inspection circuit 10E of the optical integrated circuit C according to the exemplary embodiment, it is assumed that an optical modulator 25 is an optical device 20 that is an inspection target.

The optical modulator 25 is constituted by a 2×2 Mach-Zehnder interferometer that includes two input ports and two output ports. To an input port P1 that is one of the input ports of the optical modulator 25, an optical waveguide 41 is connected, which constitutes the optical integrated circuit C and to which light is transmitted from a signal transmission light source 40. To an output port P2 that is one of the output ports of the optical modulator 25, an optical fiber 43 is connected through an optical waveguide 42. In such an optical modulator 25, signal light S5 that has been input from the signal transmission light source 40 through the optical waveguide 41 is modulated, and the modulated the signal light S5 is output to the outside from the optical fiber 43 through the optical waveguide 42.

In addition, to an input port P3 that is the other input port of the optical modulator 25, the optical waveguide 13 is connected, to which the light has been distributed using the light distributor 12 in the inspection circuit 10E. In addition, to an output port P4 that is the other output port of the optical modulator 25, a monitor receiver 45 is connected through an optical waveguide 44.

In such a configuration, the inspection light S1 that has been coupled to the optical waveguide 13 through the optical coupler 11 of the inspection circuit 10E is distributed to each of the optical modulators 25 using the light distributors 12. When the output light S2 is monitored by the monitor receiver 45, the characteristic of each of the optical modulators 25 can be inspected.

As described above, when the optical modulator 25 that includes the two input ports and the two output ports is set as the optical device 20 that is the inspection target, both signal transmission that is the original function of the optical device 20 and optical characteristic inspection of the optical device 20 can be achieved on the wafer 100.

### Sixth Exemplary Embodiment

A sixth exemplary embodiment of the present invention is described below. In the sixth exemplary embodiment that is described below, the same symbol is assigned to a configuration that is common with those of the above-described first to fifth exemplary embodiments, in the figure, and the description is omitted, and a difference from the above-described first to fifth exemplary embodiments is mainly described herein.

As illustrated in FIG. 7, an inspection circuit 10F of the optical integrated circuit C according to the exemplary embodiment includes a configuration in which a wavelength multiplexing technology is used for the inspection light S1 in addition to the configuration of the inspection circuit 10E according to the above-described fifth exemplary embodiment.

That is, the optical waveguide 13 that has been branched into a plurality of paths through a first branching filter 18 and a second branching filter 19 is connected to the input ports P3 of the optical devices 20.

In addition, an optical waveguide 48 is branched from the optical waveguide 44 that is connected to the output port P4 of each of the optical devices 20, through a branching filter 47. Such optical waveguides 48 are merged to a single optical waveguide 48 through multiplexers 50 and 50, and connected to an optical coupler 51.

In addition, the inspection light 51 that is obtained by superimposing pieces of light having a plurality of wavelengths (λ2, λ3, λ4, and λ5) that are different from a wavelength (λ1) of the signal light S5 that is output from the signal transmission light source 40 is input from the optical coupler 11, and divided into the respective wavelengths using the first branching filter 18 and the second branching filter 19, and the pieces of inspection light 51 having the different wavelengths (λ2, λ3, λ4, and λ5) for the optical devices 20, respectively are input.

The light that has passed through the optical device 20 is input to the branching filter 47, and the signal light S5 (λ1) is branched into the monitor receiver 45, and each of the pieces of output light S2 (λ2, λ3, λ4, and λ5) is branched into the optical waveguide 48. After that, the pieces of output light S2 are multiplexed in the multiplexer 50, and output from the optical coupler 51.

Thus, by analyzing the characteristic of the multiplexed output light S2 that has been output from the optical coupler 51 using a spectroscope or the like for each of the wavelengths (λ2, λ3, λ4, and λ5), the optical characteristic of the optical device 20 that corresponds to each of the wavelengths (λ2, λ3, λ4, and λ5) can be obtained.

By using the wavelength multiplexing technology as described above, the pieces of output light S2 from the plurality of optical devices 20 can be also detected so as to be output from the single optical coupler 51, so that further simple inspection can be performed.

At that time, the optical modulator 25 as the optical device 20 using the Mach-Zehnder interferometer does not have wavelength dependence in principle, so that there is no problem even when the wavelength λ1 of the signal light S5 and the wavelength (λ2, λ3, λ4, or λ5) of the inspection light S1 are different from each other. In addition, an excessive loss of the intersection between the optical waveguide 13 and the optical waveguide 48 can be suppressed using multi-layer wiring or the like.

### Seventh Exemplary Embodiment

A seventh exemplary embodiment of the present invention is described below. In the seventh exemplary embodiment that is described below, the same symbol is assigned to a configuration that is common with those of the above-described first to sixth exemplary embodiments, in the figure, and the description is omitted, and a difference from the above-described first to sixth exemplary embodiments is mainly described herein.

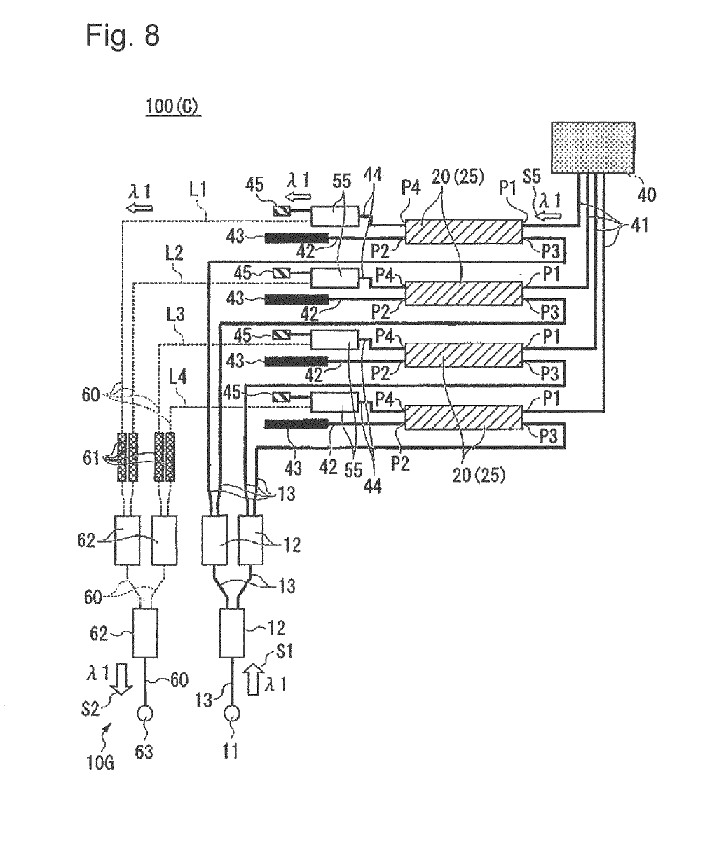

As illustrated in FIG. 8, an inspection circuit 10G of the optical integrated circuit C according to the exemplary embodiment performs time resolution by utilizing a delay that is caused by a difference of wiring lengths using the inspection light S1 having the same wavelength as that of the signal light S5, and the pieces of output light S2 are measured at the same time.

Here, in addition to the configuration illustrated in the above-described fifth exemplary embodiment, an optical switch 55 is provided in the optical waveguide 44 that is connected to the output port P4 of each of the optical devices 20. To such an optical switch 55, the monitor receiver 45 and an optical waveguide 60 are connected, and the connection destination can be switched. Here, the paths L1 to L4 are set so that the path lengths between the optical devices 20 and an optical coupler (output optical coupler) 63 are different from each other.

The optical waveguides 60 are merged into a single optical waveguide 60 through optical multiplexers 62 and 62, and such a single optical waveguide 60 is connected to the optical coupler 63.

In the inspection circuit 10G having such a configuration, the inspection light S1 having the same wavelength as that of the signal light S5 from the signal transmission light source 40 is input through the optical coupler 11.

At the time of inspection, using the optical switch 55, the output light S2 that has been output from each of the optical modulators 25 is output to the optical waveguide 60. At that time, pieces of inspection information of the optical modulators 25 are respectively included in the pieces of output light S2 having the same wavelength, but in the paths L1 to L4 having different path lengths, delay of the output of the output light S2 occurs depending on the path length. Thus, by performing time resolution on the output light S2 that is output from the optical coupler 63, inspection of each of the optical modulators 25 can be performed.

It is noted that, when a further larger time difference is required for the output light S2 that is output from the optical coupler 63 due to the time resolution, it is desirable that an optical delay circuit 61 is provided in each of the optical waveguides 60.

As described above, the pieces of output light S2 from the plurality of optical devices 20 can be caused to be output from the single optical coupler 63 and be detected by using time delay depending on a different path length, so that the simple inspection can be performed.

### Eighth exemplary embodiment

An eighth exemplary embodiment of the present invention is described below. In the eighth exemplary embodiment that is described below, the same symbol is assigned to a configuration that is common with those of the above-described first to seventh exemplary embodiments, in the figure, and the description is omitted, and a difference from the above-described first to seventh exemplary embodiments is mainly described herein.

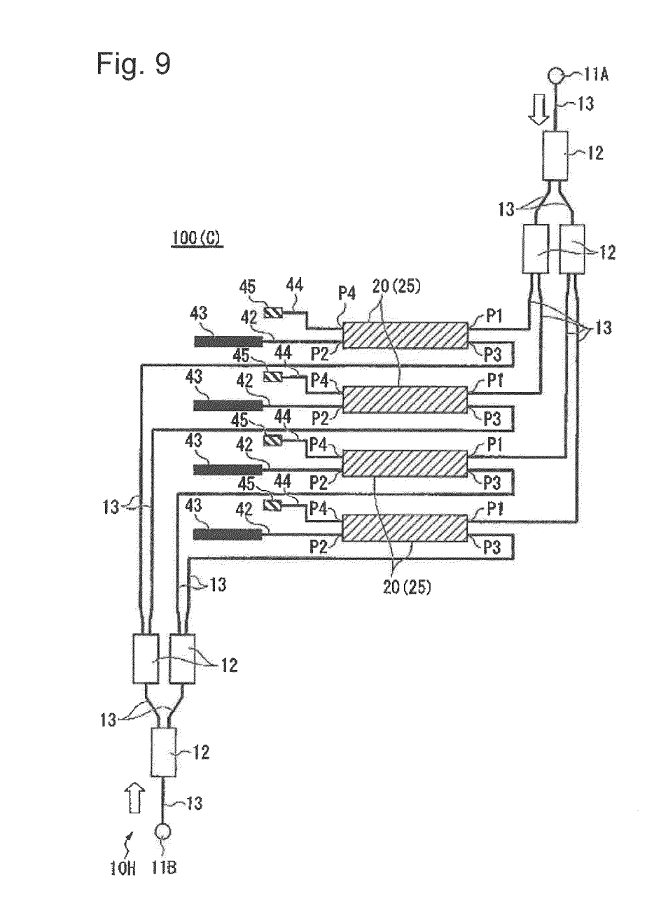

As illustrated in FIG. 9, in an inspection circuit 10H of the optical integrated circuit C according to the exemplary embodiment, a plurality of optical couplers 11A and 11B that is used to perform input of the inspection light S1 is provided.

That is, the optical waveguides 13 are provided that have been branched from the two optical couplers 11A and 11B through the light distributors 12, 12, . . . .

In addition, to one of the two input ports of each of the optical modulators 25 that is the inspection target, the optical waveguide 13 that is branched from the optical coupler 11A is connected, and to the other input port, the optical waveguide 13 that is branched from the optical coupler 11B is connected.

In the inspection circuit 10H having such a configuration, the two optical couplers 11A and 11B are provided as inspection ports, and optical characteristics of the optical modulators 25 are respectively evaluated from light that has been input from the optical coupler 11A and light that has been input from the optical coupler 11B. In addition, an average of both of the obtained optical characteristics can be calculated, or the detected result can be set valid when a difference between the obtained optical characteristics is within a certain range.

As a result, the effect that is attributed to a variation in the characteristics of the optical couplers 11A and 11B, the light distributor 12, and the optical waveguide 13 can be further reduced. In addition, when the characteristics are different depending on both of the input ports of the optical modulator 25, the variation or the like can be inspected.

### Other Exemplary Embodiments

It is noted that the optical integrated circuit and an inspection method of an optical device in the optical integrated circuit according to the present invention are not limited to the exemplary embodiments that are described above with reference to the drawings, and various modifications are conceivable within the technical range.

For example, in the above-described fifth to eighth exemplary embodiments, as the optical device 20, the optical modulator 25 that includes the two input ports and the output ports is described, but the number of ports may be three ports or more. In addition, in the case of the plurality of ports, the optical device 20 other than the optical modulator 25 may be an inspection target.

In addition, in the inspection circuits 10A to 10H, the inspection is performed in the state of the wafer 100, and the optical couplers 11, 11A, and 11B are eliminated by etching or the like after non-defective selection has been performed, and one or plurality of signal transmission light sources may be provided.

In addition, the configurations that are described in the above first to eighth exemplary embodiments can be combined as appropriate.

In addition to the above descriptions, without departing from the gist of the present invention, it is possible to make a decision to adopt or reject the configurations according to the above-described exemplary embodiments and modify the configuration into a further configuration as appropriate.

This application is based upon and claims the benefit of priority from Japanese Patent Application No. 2012-188510, filed on Aug. 29, 2012, the disclosure of which is incorporated herein in its entirety by reference.

### INDUSTRIAL APPLICABILITY

The present invention can be used in an optical communication system and an optical information processing system. In the present invention, the characteristics of a large number of optical devices can be inspected simply and reliably in a wafer state.

### REFERENCE SIGN LIST

10A to 10H Inspection circuit
11, 11A, and 11B Optical coupler
12 Light distributor
13, 13A, 13B, and 13C Optical waveguide
18 and 19 Branching filter
20 Optical device
25 Optical modulator
30A and 30B Reference optical waveguide
40 Signal transmission light source
41, 42, and 44 Optical waveguide
43 Optical fiber
45 Monitor receiver
47 Branching filter
48 Optical waveguide
50 Multiplexer
51 Optical coupler (output optical coupler)
55 Optical switch
60 Optical waveguide
61 Optical delay circuit
62 Optical multiplexer
63 Optical coupler (output optical coupler)
100 Wafer (semiconductor substrate)
200 Chip
L1 to L8 Path
P1 Input port
P2 Output port
P3 Input port
P4 Output port
S1 Inspection light
S2 Output light
S5 Signal light

What is claimed is:

1. An optical integrated circuit comprising:
an optical coupler configured to receive inspection light through a surface of a semiconductor substrate;
an optical waveguide configured to propagate the inspection light that is received at the optical coupler;
a light distributor configured to distribute the inspection light that is propagated through the optical waveguide, to a plurality of optical waveguides; and
optical devices that are connected to the plurality of optical waveguides to which the inspection light is distributed using the light distributor.

2. The optical integrated circuit according to claim 1, wherein
the optical device includes a plurality of input ports, and inspection light that is used to inspect an optical characteristic of the optical device is input to at least one of the input ports from the plurality of optical waveguides.

3. The optical integrated circuit according to claim 1, wherein
path lengths of the plurality of optical waveguides that are respectively provided between the optical devices and the optical coupler are equal.

4. The optical integrated circuit according to claim 1, wherein
the light distributor performs the distribution of the inspection light so that the pieces of energy of inspection light that are input to the optical devices are equal.

5. The optical integrated circuit according to claim 1, wherein
among the plurality of optical waveguides, at least either materials that respectively form the plurality of optical waveguides or path lengths of the plurality of optical waveguides from the optical coupler to the optical devices are different from each other, and
the plurality of optical waveguides is set so that the pieces of energy of the inspection light that are input to the optical devices become equal.

6. The optical integrated circuit according to claim 1, wherein
two or more reference optical waveguides each of which is merely constituted by an optical waveguide are provided in addition to the plurality of optical waveguides in which the optical devices are respectively provided, and the inspection light is distributed from the light distributor to the reference optical waveguides in addition to the plurality of optical waveguides.

7. The optical integrated circuit according to claim 1, wherein
a plurality of chips on each of which the one or more optical devices are provided, are provided on the semiconductor substrate, and
the plurality of optical waveguides that are branched by using the light distributor are distributed to the plurality of chips and connected to the optical devices.

8. The optical integrated circuit according to claim 1, wherein
the light distributer divides inspection light that is obtained by superimposing pieces of light having different wavelengths, into the pieces of light having the different wavelengths, and outputs the pieces of light to the plurality of optical waveguides, respectively, and
the optical integrated circuit further comprising:
a multiplexer configured to superimpose pieces of output light that pass through the optical devices in the respective plurality of optical waveguides, and merge the pieces of output light into a single optical waveguide; and
an output optical coupler configured to output the output light that passes through the multiplexer, externally.

9. The optical integrated circuit according to claim 1 further comprising:
an optical merger configured to merge pieces of output light having different delay times through the optical devices in the respective plurality of optical waveguides, into a single optical waveguide; and
an output optical coupler configured to output the output light that passes through the optical merger, externally.

10. The optical integrated circuit according to claim 9 further comprising:
an optical delay circuit configured to assign different delay times to the pieces of output light that pass through the optical devices in the respective plurality of optical waveguides.

11. The optical integrated circuit according to claim 1, wherein
a plurality of sets of the optical coupler, the light distributor, the optical waveguide, and the plurality of optical waveguides are connected to a single optical device.

12. An inspection method of the optical device in the optical integrated circuit according to claim 1, the inspection method comprising:
receiving the inspection light through the optical coupler;
distributing the inspection light to the plurality of optical waveguides by using the light distributor; and
evaluating an optical characteristic of the optical device based on output light that is obtained by causing the distributed inspection light to pass through the optical device.

13. The inspection method of the optical device in the optical integrated circuit according to claim 12, wherein
the optical device is evaluated by taking out the output light that passes through the optical device, externally, and detecting an optical characteristic of the taken-out output light.

14. The inspection method of the optical device in the optical integrated circuit according to claim 12, wherein
the output light that passes through the optical device is converted into an electrical signal by an optical receiver and output externally, and an optical characteristic of the optical device is evaluated based on the output electrical signal.

15. The inspection method of the optical device in the optical integrated circuit according to claim 1, wherein
the three or more optical waveguides in which the optical devices are respectively provided are provided, and the path lengths of the optical waveguides that are provided between the optical coupler and all of the optical devices are different from each other, and
based on evaluation results of optical characteristics of the optical devices that are respectively provided in the two optical waveguides having different path lengths, a reference value of an optical characteristic in the optical device that is provided in the optical waveguide having a further path length is calculated, and an optical characteristic in the optical device that is provided in the optical waveguide having the further path length is evaluated based on the reference value.
